(19) United States
(12) Patent Application Publication
(10) Pub. No.: US 2018/0069959 A1
(43) Pub. Date: Mar. 8, 2018

(54) Bidirectional telephonic communication network initiated by radio or computer aided dispatch system

(71) Applicant: Preston L Ursini, Paducah, KY (US)

(72) Inventor: Preston L Ursini, Paducah, KY (US)

(21) Appl. No.: 15/664,872

(22) Filed: Jul. 31, 2017

Related U.S. Application Data
(60) Provisional application No. 62/337,331, filed on Aug. 1, 2016.

(51) Int. Cl. H04M 3/42; H04W 76/00; H04W 4/10; H04W 4/22

(52) U.S. Cl. CPC H04M 3/42161; H04W 76/007; H04W 4/22; H04W 4/10; H04W 76/005

(57) ABSTRACT

The functionality of various methods and algorithms employing multiple sources of data that use a system storing data into a data store to be retrieved by end users through a method that allows an end user to view dispatch, radio, and/or call information on a timeline and communicate through multiple communication channels. A mixer will merge all data from each source into a linear active and/or storage stream for either live or later retrieval.

### BACKGROUND OF THE INVENTION

### Field of the Invention

The invention relates generally to a system which allows emergency and first responders to communicate with each other over a cellular or other different two-way communications network after being dispatched by an emergency dispatch center by either radio or a via computer aided dispatch system.

### Related Art

Whenever first responders, especially volunteer firefighters, are dispatched by a dispatching agency, they are generally dispatched by a radio system and sometimes via a text message and/or a mobile application notification which is initiated either by action of a computer aided dispatch system used by the agency dispatching the first responders or by a two-way radio system. Whenever dispatched only by two-way radio, some paging systems will send an alert via two-way radio which will cause the radio to make an audible sound. Some systems will use this radio paging to bridge a cellular network and send a text message and/or voice call of the radio traffic.

A two-way radio paging system may allow responders to communicate with other emergency and first responders and to the dispatching agency. A two-way radio paging system which activates a mobile cellular or application, however, does not allow users of the mobile application to communicate via voice with other responders, other users of two-way radios, or other users of the mobile application.

Emergency and first responders that receive a dispatch over a cell phone and/or mobile device have no readily accessible means of establishing two-way voice communication with other responders. This has resulted in severe fragmentation of communication systems in which an agency may utilize multiple concurrent notification systems which do not allow the users of the other systems to best communicate.

Some recorders provide a mechanism for listening to past radio traffic and some radio systems electronically transmit a unique user identification code whenever a particular user transmits data over a given frequency; however, there is no way to visually correlate after the recording which user of the radio system has transmitted a message and when that transmission took place.

Accordingly, there exists a need for a method that allows users of cellular and/or mobile devices that are utilized in these modes and in conjunction with two-way radio systems to communicate via voice and data with other users of cellular and/or mobile devices.

### SUMMARY OF THE INVENTION AND ADVANTAGES

The subject invention comprises a method for initiating a two-way communication channel between emergency and first responders using cellular networks, mobile applications, and two-way radios in a manner that allows responders using each system to communicate with each other through users of the voice and data system and to the users of other systems.

The subject invention also provides a mechanism so that radio traffic data and calls can be visually reviewed by responders and agency members after the transmission of radio data and audio data sourced from the software application for reporting and accountability purposes. The mechanism for reviewing shows timestamps of whenever radio traffic was sent, along with markers of whenever a call started. An algorithm may identify which user transmitted a radio message, along with the time the message was transmitted. If dispatched via a system which sends an electronic dispatch, that event may be visually represented by the algorithm to visually display whenever a particular unit or units were dispatched via radio.

The invention employs an algorithm that transmits voice data from cellular telephone calls initiated by a computer aided dispatch system or a radio paging system, and transits that voice traffic to other responders by a defined group of responders or persons via cellular and mobile applications, and/or to users utilizing a two-way radio network. The invention uses a database which contains a list of all responders in a specified group, and initiates an outbound telephone call to the responders based on the members within a specified group.

### BRIEF DESCRIPTION OF THE DRAWINGS

FIG. 1 is a flowchart illustrating the elements of the algorithm and method for monitoring radio traffic and forwarding it to a server.

FIG. 2 is a flowchart illustrating the method and algorithm for transmitting radio traffic from a server into a database and allowing an end user to access the data.

FIG. 3 is a mockup of a user interface which utilizes the data from the processes in the invention.

FIG. 4 is a flowchart illustrating the algorithms and method for storing audio data and its metadata from multiple sources.

FIG. 5 is an illustration demonstrating how the database will store audio data and its related metadata.

### DETAILED DESCRIPTION OF THE PREFERRED EMBODIMENT

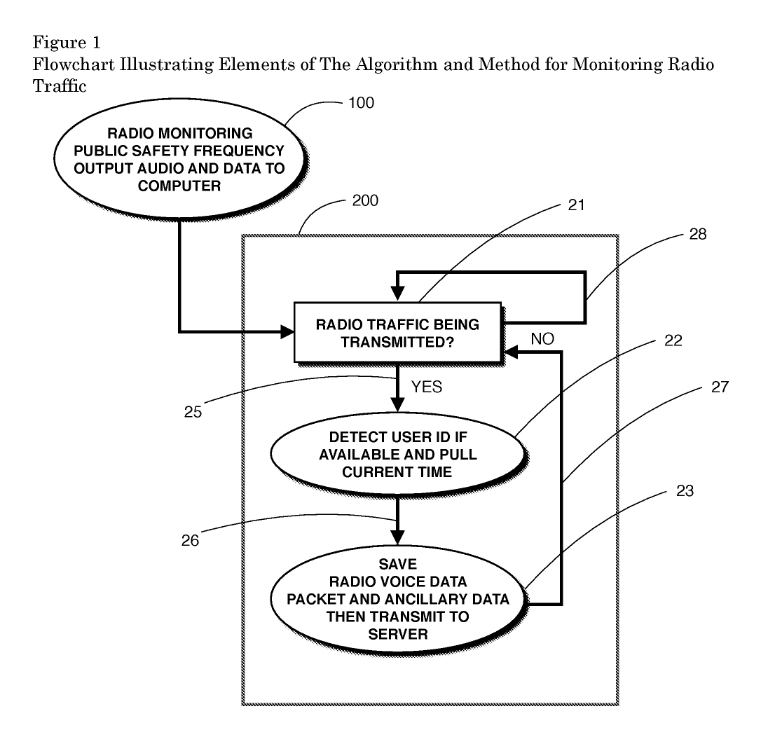

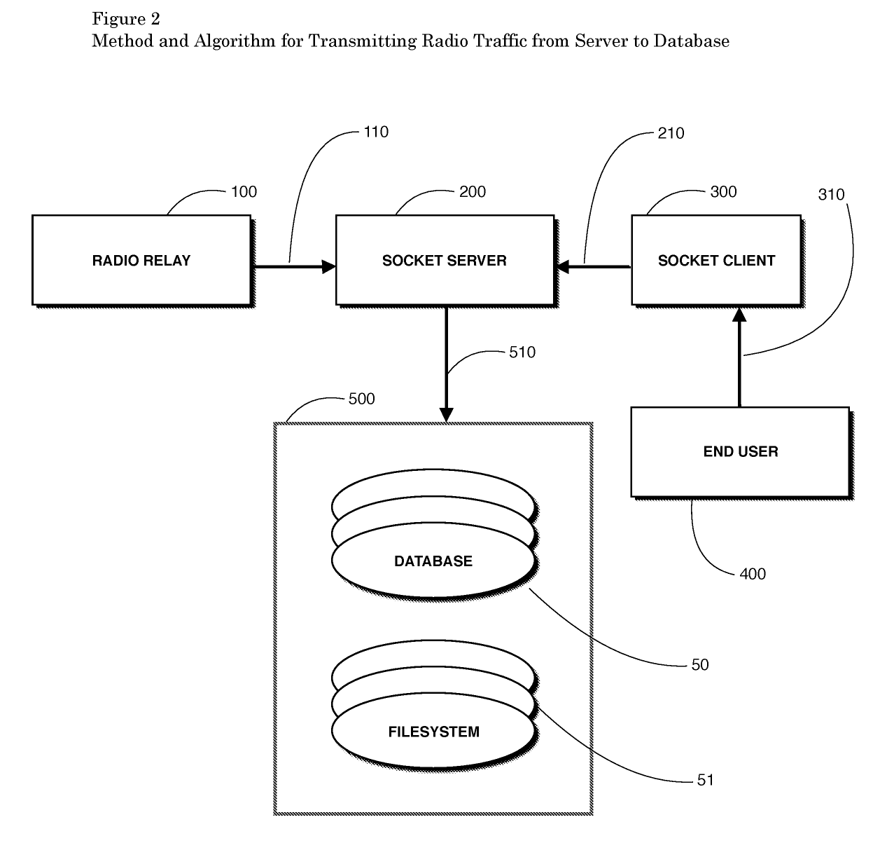

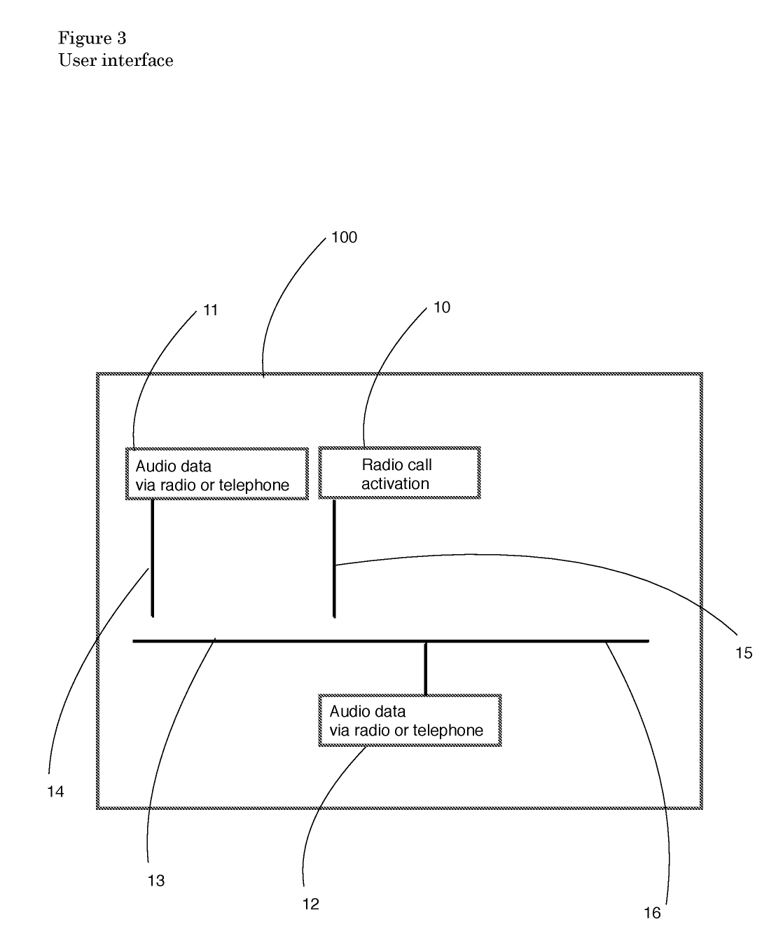

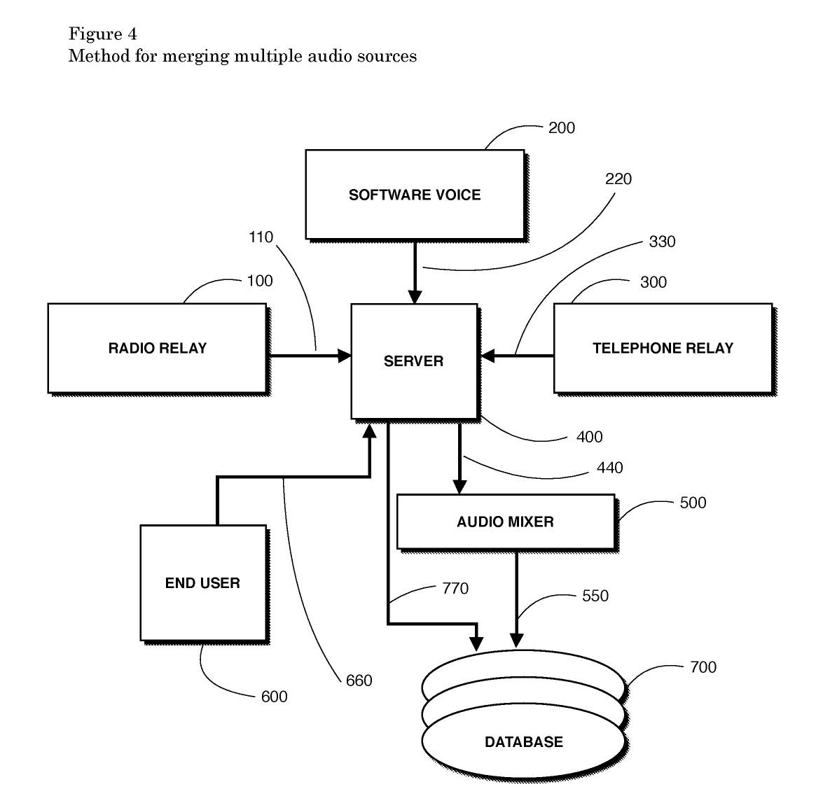

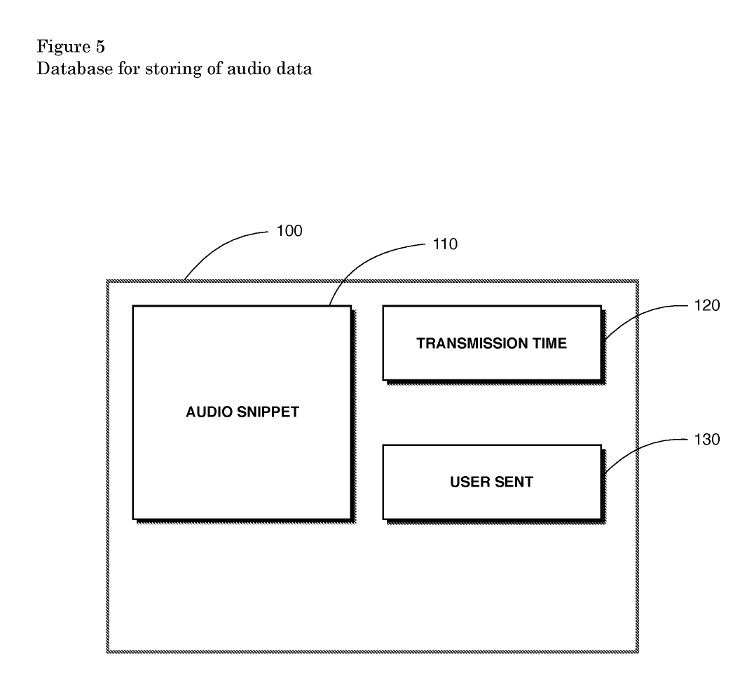

The preferred embodiment of the invention is a system that allows a first responder or other user to receive a telephone call and/or an application notification and/or telephonic source from a radio dispatch as described in FIG. 1. FIG. 1 enclosure 100 represents a two-way radio or scanner that is connected to a system which is connected to the described radio (FIGS. 1-200). The system will monitor for radio traffic using an algorithm (FIGS. 1-21). If radio traffic is present (FIGS. 1-25), the system will detect if a User ID is present and store it in the system FIGS. 5-130. Whether or not the User ID is present (FIGS. 1-26), the audio will be stored and transmitted to the server as displayed in (FIGS. 2-110) via a network socket (FIGS. 2-200). This allows the end user to listen to a dispatch from a radio system and use the system to listen to the radio traffic over a telephone (FIGS. 4-300), a software application (FIGS. 4-200) from the Radio (FIGS. 4-100). The server will monitor data from all of these sources (FIGS. 4-400), and mix the audio using an algorithm that will place the audio based on the time transmitted into a database through a mixer (FIGS. 4-500) and store it into a database (FIGS. 4-700). The end user interacts with the entire system through the server (FIGS. 4-400) the radio, a software application, and a telephone relay as displayed in FIG. 4. Communication information from each source can be differentiated by the software as flagged by the audio mixer before the data is stored in the database. (FIGS. 4-550). The user can also interact with the system through a user interface as displayed in FIG. 3, which allows the user to listen to radio, telephonic, and/or application audio and data traffic (FIGS. 3-11) the information is displayed on a timeline (FIGS. 3-17), the events on a linear scale. A radio call activation which is initiated is displayed on the timeline as a separate event, as displayed in (FIGS. 3-10). The user may speak into a telephone, radio device, and/or computer and/or mobile phone through a software application and have that information transmitted and received by other users of the system (FIG. 4). The mechanisms of sending, processing, and displaying a visual depiction of the audio may be voice activated through the audio mixer (FIGS. 4-500).

An alternative embodiment allows for a user to communicate with another user through the telephonic system and/or application system without the ability to view the data later on a timeline.

Another alternative embodiment allows for a user to view the call information for archival or other purposes on the timeline but not use the system for active communication.

1. A method and system comprising the steps of:
Monitoring a radio frequency and transmitting that radio audio data along with ancillary information whenever audio or data is present on a radio feed being fed into a machine and transmitted to a server via an Internet socket connection that allows a user to communicate with users of a two-way radio and/or other users using a computer application and/or a telephone system. Storing all audio and ancillary data so that it may be retrieved via an interactive web and/or computer interface, and each snippet and/or section of audio may be searched by either time and/or user name and/or User ID that was transmitted and stored.

2. The method as in claim 1, without the user interface which allows the user to browse through all the previous calls and/or radio data.

3. The method as in claim 1, without the ability for a user to communicate between the two-way radio system and/or otherwise the other telephonic and/or computer or mobile application.

4. The method as in claim 1, without the user interface which allows the user to browse through the previous calls and/or radio data and without the ability for a user to communicate between the two-way radio system and/or otherwise the telephonic and/or computer or mobile application.

5. The method as in claim 1, without the storage of any ancillary information and/or identifying information about the persons using the system or transmitting traffic.

6. A method for storing and transmitting radio traffic and/or telephonic and/or application activity to a server that allows it to be retrieved at a later time in the view of a timeline.

7. The method as in claim 6, without the ability to view the activity in a timeline view.
